(19) United States
(12) Patent Application Publication
(10) Pub. No.: US 2003/0008035 A1
(43) Pub. Date: Jan. 9, 2003

(54) Injection moulding machine with a closing unit with a stationary and moveable die platen

(76) Inventor: Otto Urbanek, Linz (AT)

Correspondence Address: NOTARIO & MICHALOS P.C., Empire State Building, Suite 6902, 350 Fith Avenue, New York, NY, 10118-6985, US

(21) Appl. No.: 10/187,867

(22) Filed: Jul. 2, 2002

(30) Foreign Application Priority Data
Jul. 4, 2001 (AT) A 1035/2001

(51) Int. Cl. B29C 45/66

(52) U.S. Cl. 425/593; 425/451.6

(57) ABSTRACT

An injection moulding machine with a closing unit with a stationary and a moveable die platen (1, 2) and a closing mechanism for the moveable die platen (2). The closing mechanism includes a pair of toggle levers opposite one another in mirror image, with two levers of unequal length (4, 5, 6, 7), wherein one lever (7) is pivotally connected to the stationary die platen (1) and the second lever (6) to the moveable die platen (2) respectively. Further, a drive mechanism is provided for the pairs of toggle levers (4, 5, 6, 7).

The invention relates to an injection moulding machine with a closing unit with a stationary and a moveable die platen, and a closing mechanism for the moveable die platen that includes a pair of toggle levers, each of the toggle levers having two levers of unequal length, wherein in each toggle lever one of the levers is pivotally connected to the stationary die platen and the second lever to the moveable die platen, and with a drive mechanism for the pair of toggle levers.

A dual-platen injection moulding machine is known from EP 0 835 733 with a die platen moveable by a pair of toggle levers. The pair of toggle levers is driven by a drive mechanism that is mounted on the frame of the machine.

The object of the invention is to improve an injection moulding machine of the type described in the introduction, so that during the closing procedure there is very good introduction of force, and therefore the moveable die platen is not subjected to radial stresses.

The object of the invention is solved in that the toggle levers are provided in a first common plane and are opposite one another in mirror image, with respect to a second plane perpendicular to said first plane.

It is advantageously provided that the levers of the pair of toggle levers are articulated on the same axes on the die platens.

A further advantageous embodiment of the invention provides that the two shorter arms of the pair of toggle levers are articulated on the mould height adjustment means of the moveable die platen.

A further advantageous embodiment of the invention provides that the levers are articulated about horizontal axes.

A further advantageous embodiment of the invention provides that one pair of toggle levers is provided on one side and another pair of toggle levers is provided on the opposite side of the injection moulding machine.

A further advantageous embodiment of the invention provides that said opposite sides are the vertical sides of the injection moulding machine that run parallel to the direction of motion of said moveable die plate.

An embodiment of the invention will be described hereinafter with reference to the attached drawings.

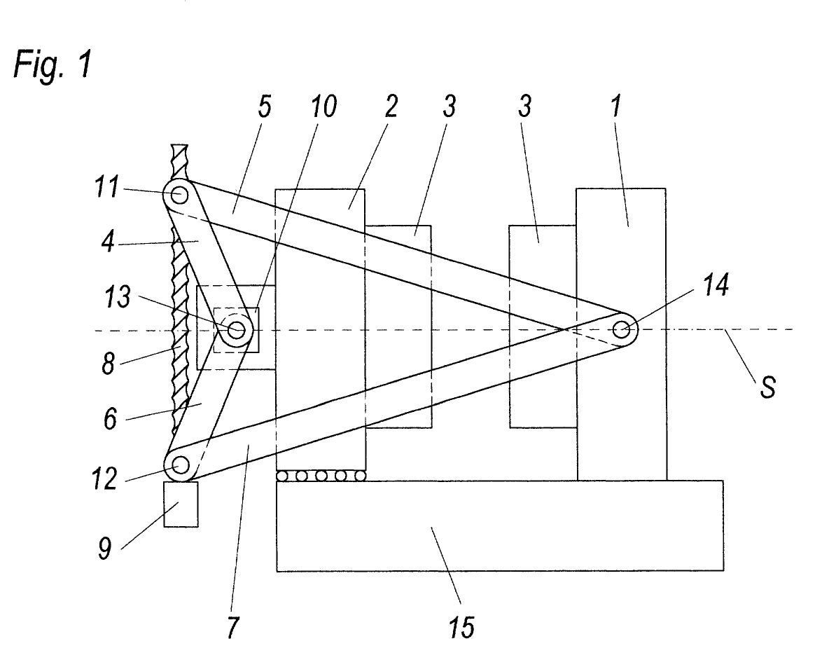

FIG. 1 shows a schematic side view of an injection moulding machine according to the invention in the open position,

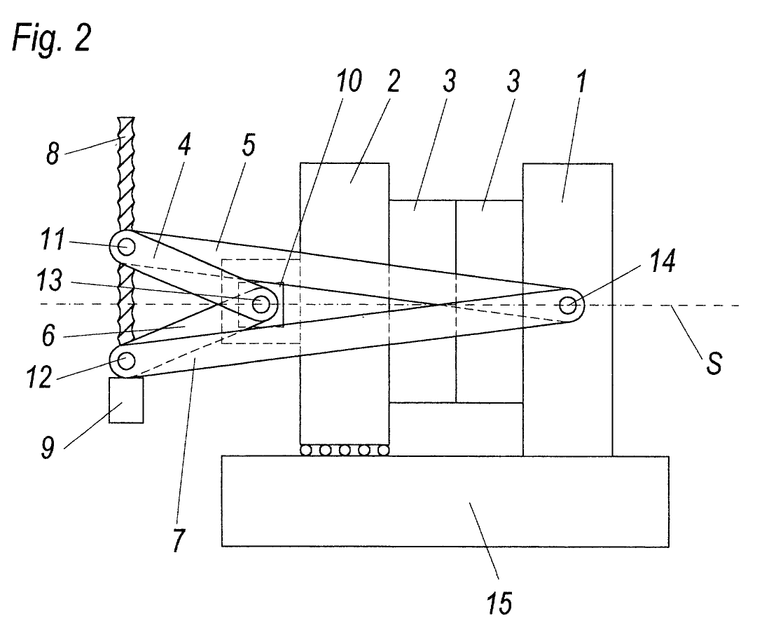

FIG. 2 shows a side view of the injection moulding machine in the closed position, and

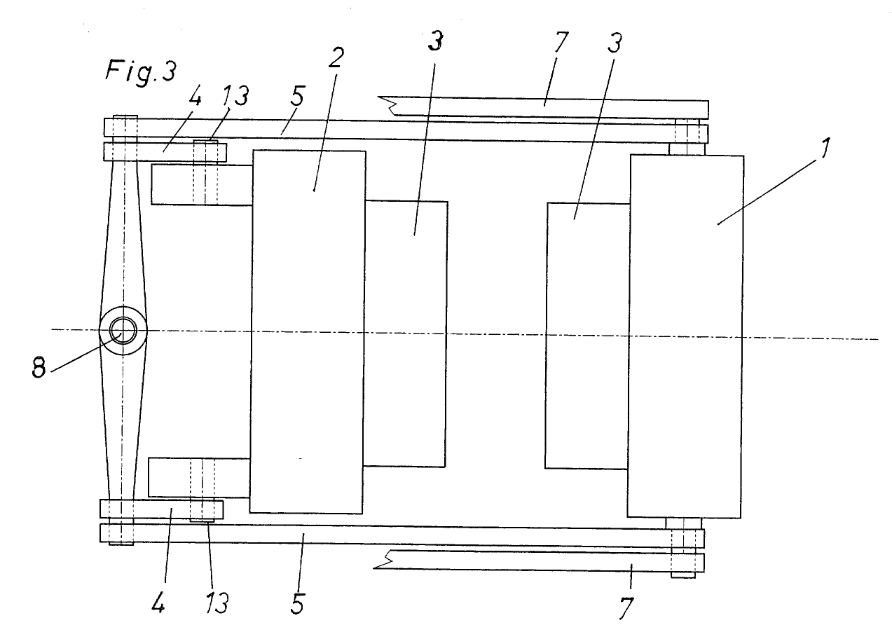

FIG. 3 shows a schematic plan view of an injection moulding machine according to the invention in the open position.

The injection moulding machine according to the invention includes a closing unit with the stationary die platen 1 and a moveable die platen 2, to which the two mould halves 3 are attached.

The moveable die platen 2 is displaced and is kept in the closed position by means of two toggle levers 4, 5 and 6, 7, that are opposite one another in mirror image with respect to a plane S perpendicular to the common plane of the toggle levers 4, 5 and 6, 7. Two pairs of toggle levers 4, 5 and 6, 7 are arranged on two opposite sides of the injection moulding machine and respectively the closing unit. The two toggle levers 4, 5, 6, 7 of each pair respectively lie in a plane opposite one another in mirror image. When closing and opening, the toggle joints 11, 12 of the two toggle levers 4, 5, 6, 7 of each pair move in opposite directions.

Each toggle lever is provided with a shorter lever 4, 6 and a longer lever 5, 7. The levers 4, 5, 6, 7 are pivotable about horizontal axes.

The longer levers 5, 7 are articulated on a bearing point 14 on the stationary die platen 1.

The shorter levers 4, 6 bear upon a bearing point 13 on the mould height adjustment means 10 that is carried by the moveable die platen 2.

The drive mechanism for the two pairs of toggle levers 4, 5, 6, 7 is formed by a spindle 8 and a servo-motor 9. The spindle 8 is mounted on the toggle joints 11, 12 of the pairs of toggle levers 4, 5 and 6, 7 and is carried by the pairs of toggle levers 4, 5, and 6, 7 free of the machine frame 15.

When the two mould halves 3 are closed, the introduction of force takes place via the two pairs of toggle levers 4, 5 and 6, 7 exactly in the plane of symmetry S of the injection moulding machine.

1. Injection moulding machine with a closing unit with a stationary and a moveable die platen and a closing mechanism for the moveable die platen that includes a pair of toggle levers each of the toggle levers having two levers of unequal length, wherein in each toggle lever one of the levers is pivotally connected to the stationary die platen and the second lever to the moveable die platen, and with a drive mechanism for the pair of toggle levers, characterised in that the toggle levers are provided in a first common plane and are opposite one another in mirror image, with respect to a second plane perpendicular to said first plane.

2. Injection moulding machine according to claim 1, characterised in that the levers are articulated about the same axes on the die platens.

3. Injection moulding machine according to claim 1, characterised in that the two shorter arms of the pair of toggle levers are articulated on the mould height adjustment means of the moveable die platen.

4. Injection moulding machine according to claim 1, characterised in that the levers are articulated about horizontal axes.

5. Injection moulding machine according to claim 4, characterised in that the levers are articulated about the same axes on the die platens.

6. Injection moulding machine according to claim 5, characterised in that the two shorter arms of the pair of toggle levers are articulated on the mould height adjustment means of the moveable die platen.

7. Injection moulding machine according to claim 4, characterised in that the two shorter arms of the pair of toggle levers are articulated on the mould height adjustment means of the moveable die platen.

8. Injection moulding machine according to claim 1, characterised in that one pair of toggle levers is provided on one side and another pair of toggle levers is provided on the opposite side of the injection moulding machine.

9. Injection moulding machine according to claim 8, characterised in that said opposite sides are the vertical sides of the injection moulding machine that run parallel to the direction of motion of said moveable die plate.

10. Injection moulding machine according to claim 9, characterised in that the levers are articulated about the same axes on the die platens.

11. Injection moulding machine according to claim 10, characterised in that the two shorter arms of the pair of toggle levers are articulated on the mould height adjustment means of the moveable die platen.

12. Injection moulding machine according to claim 11, characterised in that the levers are articulated about horizontal axes.
